(19) United States
(12) Patent Application Publication
(10) Pub. No.: US 2022/0064028 A1
(43) Pub. Date: Mar. 3, 2022

(54) DIRECT ELECTROCHEMICAL REDUCTION METHOD FOR REMOVING SELENIUM FROM WASTEWATER

(71) Applicant: The Board of Trustees of the Leland Stanford Junior University, Stanford, CA (US)

(72) Inventors: Meagan S. Mauter, Palo Alto, CA (US); Shiqiang Zou, Auburn, AL (US)

(21) Appl. No.: 17/461,478

(22) Filed: Aug. 30, 2021

Related U.S. Application Data
(60) Provisional application No. 63/073,583, filed on Sep. 2, 2020.

(51) Int. Cl. C02F 1/469

(52) U.S. Cl. CPC C02F 1/4691; C02F 2101/106; C02F 2209/06; C02F 2209/02

(57) ABSTRACT

Methods for selenium removal from wastewater are provided using direct electrochemical reduction. Advantageously, the technique can efficiently and continuously treat weakly acidic wastewater (pH 4-7) with 0.001-10 mM Se(IV) concentrations in a weakly acidic solution. Embodiments of the invention include Se(IV) electrochemically removed from the aqueous phase through either a four- or six-electron pathway, with the former generating Se(0) directly attached to the electrode surface and the latter producing Se(-II) that is subsequently converted to Se(0). A key feature of these embodiments is the use of moderate heating to ensure the process takes place at an elevated temperature (e.g., temperatures above the amorphous-to-crystalline transition for Se(0)), which the inventors discovered results in the creation of conductive crystalline Se on an electrode surface, thereby avoiding self-limiting nature of prior techniques which result in insulative amorphous deposition of Se(0) on the electrode.

### CROSS-REFERENCE TO RELATED APPLICATIONS

This application claims priority from U.S. Provisional Patent Application 63/073,583 filed Sep. 2, 2020, which is incorporated herein by reference.

### STATEMENT OF GOVERNMENT SPONSORED SUPPORT

This invention was made with Government support under contract 2023833 awarded by the National Science Foundation. The Government has certain rights in the invention.

### FIELD OF THE INVENTION

This invention relates generally to methods for wastewater treatment. More specifically, it relates to methods for removing selenium (Se) from wastewater.

### BACKGROUND OF THE INVENTION

Selenium (Se) is a naturally occurring metalloid in earth crust that is released through natural weathering processes. Anthropogenic activities have significantly accelerated geogenic release, increasing Se concentrations in aquatic environments far beyond the ppb levels required for biologic function. Coal-fired power plant flue-gas desulfurization (FGD) wastewater, for example, contains 1-10 mg L⁻¹ Se. Applications of Se-containing fertilizers coupled with water-intensive irrigation generate Se-laden agricultural drainage (100-1500 μg L⁻¹), and mining activities commonly discharge Se at a level of 15-50 μg L⁻¹ into the aquatic environment. This anthropogenic Se is primarily released as Se(IV) and Se(VI) oxyanions (e.g., SeO₃²⁻ and SeO₄²⁻), but also includes selenocyanates (SeCN⁻), mercury selenide (HgSe), and organic Se compounds. Accumulation of Se in aquatic environments leads to bioaccumulation and ecosystem impacts, drinking water violations, and chronic health issues. Treatment of high-volume industrial and agricultural wastewaters is essential for complying with water quality criteria for aquatic life (1.5 and 3.1 μg L⁻¹ for lentic and lotic aquatic systems) and drinking water standards (50 μg L⁻¹).

Conventional Se control practices use biological or physicochemical driving forces to remove Se from wastewater. In biological treatment, Se-reducing bacteria either reduce Se(VI) extracellularly through a surface-displayed enzyme (e.g., gram-positive bacteria such as B. selenatarsenatis SF-1), or assimilate Se(VI) into periplasm or cytoplasm for biomineralization (e.g., gram-negative bacteria such as E. cloacae SLD1a-1). The generated Se(IV) is further reduced to elemental Se(0) via a microbial detoxification pathway, followed by excretion of Se(0) particles into the environment. In recent years, pilot- and even full-scale bioremediation processes have been commercialized to provide 99% Se removal from incoming wastewater streams, and biological Se removal is included as a “best available technology” in the U.S. EPA's Effluent Limitation Guidelines (ELGs) for the steam electric power generating category. However, biological Se removal is highly sensitive to wastewater composition (e.g., sufficient carbon source, appropriate wastewater pH, few toxic substances, and low concentrations of competing oxyanions) and operation parameters (e.g., pretreatment, hydraulic retention time, and operating temperature). Organic Se compounds are a frequent byproduct, and many of these compounds are significantly more bioavailable and potentially more toxic than inorganic Se. Finally, management of Se-rich biosolids increases the operating costs of biological processes.

In contrast, physicochemical Se removal processes either rely on extensive chemical addition (e.g., Mg—Al—CO₃ sorbents, Al-based coagulants) in wastewater matrix to capture Se, or pressure-driven membrane filtration to separate Se from the aqueous phase. The efficacy of reductive reagents and anion exchange resins has been demonstrated for chemisorbing Se oxyanions in the wastewater. Other work demonstrated electrosorption for environmental contaminant removal (e.g., heavy metals and Se) or indirect electrochemical removal using a sacrificial iron anode to release reductive iron reagents. While these physicochemical approaches are capable of providing consistent effluent quality and a reliable Se removal performance (i.e., down to the ppb level), key issues with physiochemical approaches include the generation of a large amount of solid residuals, high operational cost due to materials and solid management, elevated energy input for media regeneration, limited selectivity for Se removal in complex wastewater matrices, and mandatory system maintenance (e.g., membrane cleaning). In short, existing Se removal processes are energy-, resource-, and cost-intensive, driving new process development to eliminate Se oxyanions in a sustainable and economically competitive manner.

In recent years, direct electrochemical reduction (DER) has been explored for efficient ion removal (e.g., nitrate, chromate) from wastewater. In a DER process, the cathode potential is precisely controlled to match the reduction potential of the target ions, enabling specific ion reduction in a complex water matrix. DER approaches offer several advantages over indirect electrochemical reduction, including selective ion removal, fewer parasitic reactions, and reduced energy consumption. The absence of sacrificial reactions at the anode may also prolong the electrode lifespan, reduce solid production, and enable continuous process operation. DER has been extensively implemented in industrial Se plating (known as electroplating or electrodeposition) for decades on various metal surfaces, such as gold, silver, nickel, and iron. Before electroplating, selenium dioxide or selenite salt is added into an acid bath (pH≤2) to prepare the plating substrate (1-10 mM Se). The Se(IV) in the substrate is then reduced to elemental Se during electroplating, forming a thin layer of elemental Se on the target metal surface.

Environmental applications of Se removal via DER require mechanistic insight into the thermodynamics and kinetics of the SeDER process as a function of Se oxidation state, solution pH, Se concentration, and temperature. For example, FGD wastewater is only weakly acidic (pH=4-7) and contains comparably low levels of selenite, selenate, and other Se species (0.01-1 mM). Recently, Se removal via DER (SeDER) was performed on a strongly acidic copper refining wastewater (pH=0.3 and 3.8 mM Se) in a cyclone electrowinning reactor, and 97.6% of Se(IV) was reduced to red Se(0) within 90 mins with a faradaic efficiency of 70.6% and specific energy consumption of 0.20 kWh kg⁻¹ Se. To date, however, the inventors are unaware of other efforts demonstrating SeDER from more characteristically dilute and neutral wastewater streams. The present invention advances the art in developing direct electrochemical reduction methods for removing selenium from wastewater.

### SUMMARY OF THE INVENTION

### Definitions

Direct electrochemical reduction method is defined as reducing target substance(s) by receiving electrons directly from the electrode (i.e., the cathode) in an electrochemical system. After receiving electrons, the target substance(s) is directly reduced at the electrode-solution interface. Thus, reduction is a direct result of electrochemical reactions.

Indirect electrochemical reduction method is defined as reducing target substance(s) by receiving electrons from electrochemically generated reducing agent(s) in an electrochemical system. The reducing agent(s) can be electrochemically generated either on the anode electrode (e.g., Fe(II) from a sacrificial Fe anode) or the cathode electrode (e.g., hydrogen gas from a hydrogen evolution reaction). The target substance(s) receives electrons from electrochemically generated reducing agent(s) through solution-phase chemical redox reactions. Thus, reduction is an indirect result of electrochemical reactions.

Chronoamperometry is an electrochemical technique in which a constant potential is applied to an electrode. The resulting current from faradaic processes occurring at the electrode (caused by the applied constant potential) is monitored as a function of time.

Wastewater is used water that has been affected by domestic, industrial, and commercial use. Compared to natural water (e.g., surface water and groundwater) and drinking water, wastewater has a highly variable composition and contains organic matter, inorganic compounds, and microorganisms.

### SUMMARY

Direct electrochemical reduction provides a new strategy for selenium removal from complex wastewaters. While electrochemical Se(IV) reduction is thermodynamically favorable, anion structure reorganization hinders process kinetics and the phase of reduced Se(0) determines process performance. For the purposes of this invention, the inventors evaluated the thermodynamic and kinetic performance of Se(IV) removal via direct electrochemical reduction (SeDER) and proposed moderate heating to promote efficient and continuous process operation.

The inventors have found that SeDER is a robust process that can handle 0.001-10 mM Se(IV) in a weakly acidic solution (pH 4-7). Se(IV) can be electrochemically removed from the aqueous phase through either a four- or six-electron pathway, with the former generating Se(0) directly attached to the electrode surface and the latter producing Se(−II) that is subsequently converted to Se(0). The four-electron pathway is a surface-limited process below 70° C. and terminates when cathode is fully covered with the insulative amorphous Se(0). The inventors further demonstrated that raising the solution temperature to 80° C. deposits Se(0) in a conductive crystalline form and enables continuous reduction on the electrode surface. In an exemplary batch process design, the inventors observed Se(IV) removal rates of up to 89 mg h⁻¹ m⁻² of electrode surface area, up to 10% Faradaic efficiency, and up to 95% removal, though they observed moderate tradeoffs between these metrics depending on the electron pathway and the initial concentration of Se(IV). Faradaic efficiency could be further enhanced via better reactor and electrode design, preventing parasitic reactions induced by competing ions, and selection of alternative electrode materials that favor SeDER reactions.

In one example, the invention can be described as a method for selenium removal from wastewater using direct electrochemical reduction. Advantageously, the technique can efficiently and continuously treat weakly acidic wastewater (pH 4-7) with 0.001-10 mM Se(IV) concentrations in a weakly acidic solution. Embodiments of the invention include Se(IV) electrochemically removed from the aqueous phase through either a four- or six-electron pathway, with the former generating Se(0) directly attached to the electrode surface and the latter producing Se(−II) that is subsequently converted to Se(0). A key feature of these embodiments is the use of moderate heating to ensure the process takes place at an elevated temperature (e.g., temperatures above the amorphous-to-crystalline transition for Se(0)), which the inventors discovered results in the creation of conductive crystalline Se on an electrode surface, thereby avoiding self-limiting nature of prior techniques which result in insulative amorphous deposition of Se(0) on the electrode. Moreover, the inventors recognized that chronopotentiometry methods (constant current methods) reduce other ions alongside Se due to voltage variation. In contrast, the embodiments of the invention provide a process that is able to selectively reduce Se without reducing other competing ions in solution by using chronoamperometry—i.e., fixed voltage, changing current—to reduce Se. In the present discussion, competing ions are defined to exclude hydrogen ions (H+) which exist in all water matrices. Avoiding reduction of competing ions 1) allows the process to be efficient (maximize the fraction of electrons doing productive separations work, rather than reducing ions that are irrelevant) and 2) enables recovery of high purity Se(0), rather than a mixture, thereby reducing the cost of solid waste disposal and enabling valorization of the recovered Se(0) product.

In one example, the invention is a method for removing selenium from wastewater using a direct electrochemical reduction. Wastewater is passed through a reactor containing electrodes. In one example, the electrodes are an Au electrode, an Ag/AgCl electrode and a Pt electrode. A predetermined electric potential is applied between the electrodes immersed in the wastewater, while the reactor has a pH of 4-7.

In one example, one uses chronoamperometry to control the predetermined electric potential at a constant voltage and a changing current. In the example where two of the electrodes are an Au electrode and an Ag/AgCl electrode, the constant voltage on the Au electrode is between 0.0V to −0.4V versus the Ag/AgCl reference electrode, where the Ag/AgCl reference electrode has a 3.5M potassium chloride filling solution. In another example, the predetermined electric potential produces a current density of less than 1.5 A/m².

In one example, where one of the electrodes is an Au electrode, and where the deposited crystalline selenium on the Au electrode can reach a deposition capacity of at least 3.0 g Se per square meter electrode surface area.

The method further includes controlling the temperature of the wastewater between the electrodes so that it attains a temperature above the amorphous-to-crystalline transition for Se(0). The temperature is controlled to be above 75° C., or 80° C. or more.

Periodically one would remove crystalline selenium deposited on one of the electrodes from the reactor.

In one example, the wastewater contains Se concentrations of 0.0001M to 0.001M, nitrate concentrations of 0 to 0.01M, sulfate concentrations of 0 to 0.2M, chloride concentrations of 0 to 0.5M, or any combination thereof.

In one embodiment, the method selectively reduces selenium through 4 and 6 electron pathways, thereby avoiding reduction of competing ions.

Comparing to existing biological and physicochemical Se treatment processes, the main advantages of embodiments of this invention are:

(1) no generation of organic selenium in the treated wastewater, thereby reducing the bioavailability and bioaccumulation of organic selenium in the treated wastewater (as compared to the biological process).

(2) no solid generation in the treated wastewater in the four-electron Se(IV)/Se(0) pathway, thereby reducing the cost of solid waste disposal and the possibility of secondary Se pollution in landfill leachate (as compared to the physicochemical process).

(3) minimal chemical addition to remove Se from wastewater, thereby reducing the cost of purchase, transport, and storage of spent materials (as compared to both biological and physicochemical methods).

(4) recovery of high purity Se(0) in its conductive crystalline form on the electrode surface, thereby enabling valorization of the recovered Se(0) product (as compared to both biological and physicochemical processes).

(5) easy electrode regeneration through electrochemical oxidation to fully restore the electrode performance for subsequent Se removal operations, thereby requiring minimal maintenance effort and less O&M cost in the long run (as compared to both biological and physicochemical processes).

(6) high selectivity towards Se oxyanions at variable concentrations to remove up to 95% Se from complex water matrix containing competing ions (as compared to both biological and physicochemical processes).

### BRIEF DESCRIPTION OF THE DRAWINGS

FIG. 1 shows according to an exemplary embodiment of the invention a direct electrochemical reduction to efficiently remove Se(IV) oxyanions, providing a reliable strategy to manage Se contamination in aquatic environment.

FIGS. 2A-E show a direct electrochemical selenium reduction under weakly acidic environment regarding (FIG. 2A) CV scan for blank control, 1-mM selenite, and 1-mM selenate solution under a solution pH of 5.5; (FIG. 2B) LSV of selenite reduction under three weakly acidic and neutral pH values; (FIG. 2C) CV scans for blank and 1-mM selenate under various pH values; (FIG. 2D) LSV scans under various Se(IV) concentrations in the reduction region, with an insert zoom-in figure for blank control, 0.01-mM selenite, and 0.1-mM selenite; (FIG. 2E) LSV scans of the Au electrode with reduced Se(0) on the surface in the oxidation region. Prior to the LSV scans in (FIG. 2B) and (FIG. 2D), the cathode was placed in the aqueous solution at open circuit potential (0.35-0.75 V, depending on the pH).

FIGS. 3A-C show according to an exemplary embodiment of the invention electrochemical Se(IV) reduction under four-electron and six-electron pathways regarding (FIG. 3A) the current profile of chronoamperometry under 0.01V (underpotential deposition), −0.25V (bulk deposition), and −0.61V (six-electron reduction); (FIG. 3B) LSV of the Au electrode with reduced Se on the surface towards the oxidation region; and (FIG. 3C) schematic of four-electron and six-electron pathways with their potential application challenges.

FIGS. 4A-D show according to an exemplary embodiment of the invention electrochemical Se(IV) reduction regarding (FIG. 4A) soluble Se concentration profile in 6-hour operations with 0.1 mM Se(IV), (FIG. 4B) removal and Faradaic efficiencies for 6-hour operations with 0.1 mM Se(IV), (FIG. 4C) soluble Se concentration profile in 24-hour operations under 80° C. with 0.001 mM, 0.01 mM, and 0.1 mM Se(IV), and (FIG. 4D) Se reduction performance in 0.1 mM Se(VI), 0.1 mM Se(IV), and 0.1 mM Se(VI)+0.1 mM Se(IV) mixture under a six-electron pathway at 80° C.

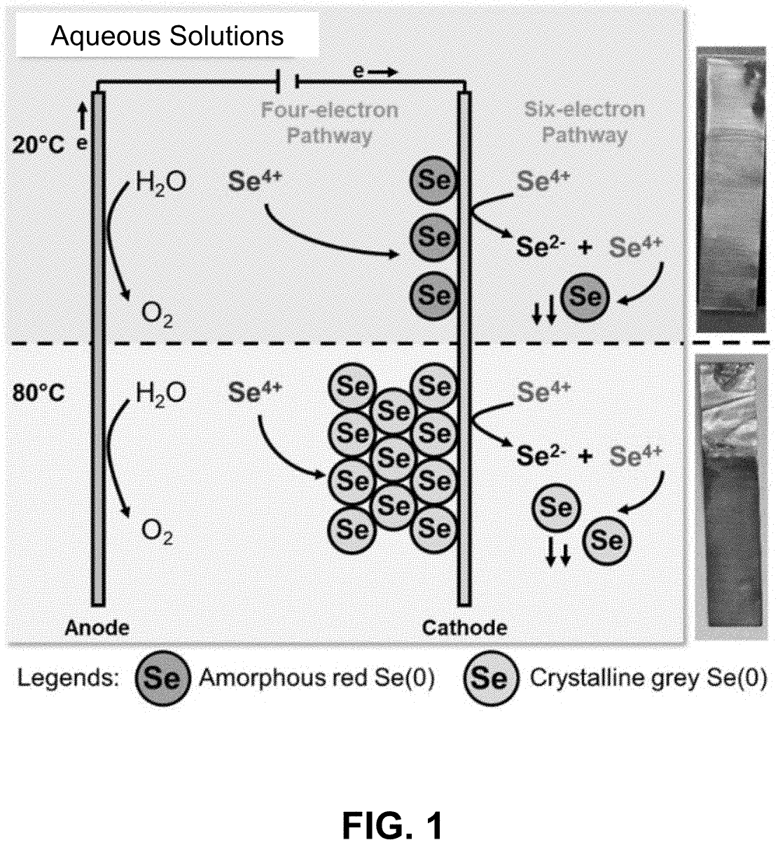

### DETAILED DESCRIPTION

For the purposes of this invention, the thermodynamic and kinetic performance of SeDER was evaluated for environmentally relevant Se concentrations and pH ranges, while also proposing new operational strategies for optimizing SeDER process performance under these conditions. The inventors investigated (1) the feasibility of Se(IV)DER and Se(VI)DER in weakly acidic environments, (2) evaluated the effect of initial Se concentration and solution temperature on SeDER performance, (3) identified Se reduction pathways in simulated wastewater, and (4) quantified Se removal rate and Faradaic efficiency under long-term operation. The results from these studies resulted in energy-efficient and cost-effective electrochemical methods for meeting discharge requirements in a range of industrial and agricultural wastewaters and reducing Se contamination in local ecosystems.

Materials and Methods

Setup of the Three-Electrode Electrochemical System

The electrochemical cells had an effective working volume of 100 mL. For each experiment, one cell served as a blank control system and was filled with 100-mL 100 mM phosphate-buffered saline (PBS) solution, while the other cell was used as an experimental system and was filled with Se-spiked PBS solution. In both systems, the initial solution pH was adjusted using 1 M phosphoric acid and 1 M sodium hydroxide solution. Gold (Au) foil (Fisher Scientific, 1×5×0.125 cm, purity>99.9975%), a leakless miniature Ag/AgCl electrode (eQAD, Model ET072), and a platinum wire (CH Instrument, Model CHI 115) were used as the working electrode, reference electrode, and the counter electrode, respectively. Au was selected as the working electrode due to its excellent electrochemical stability in aqueous solutions, a wide electrochemical window, and a robust interface for oxyanion reduction and oxidative electrode cleaning. Detailed cleaning protocol of electrodes and customized 3-D printed lid design can be found in Appendix B of U.S. Provisional Patent Application 63/073,583 filed Sep. 2, 2020, which is incorporated herein by reference and to which this application claims the benefit. About 3.5 cm of the Au electrode was submerged in the solution, resulting in an effective reaction area of 7 cm². This three-electrode system was connected to an electrochemical potentiostat (BioLogic VSP-300) to conduct cyclic voltammetry (CV), linear sweep voltammetry (LSV), and chronoamperometry (CA). When heating was required, the electrochemical cell was placed in a sand bath on top of a magnetic stirrer hot plate to maintain a constant solution temperature. All chemicals used are purchased from Fisher Scientific and used directly without further purification (purity>99.8%). Water was from a Millipore Milli-Q system.

Experimental Procedure

First the feasibility of electrochemical Se reduction was explored under weakly acidic and neutral environments. The initial solution pH was adjusted to 4.0, 5.5, and 7.0 for both control and experimental systems to simulate the pH of common industrial and agricultural wastewaters. In the experimental system, sodium selenite (Na₂SeO₃) or selenate (Na₂SeO₄) was added to maintain an initial concentration of 1-mM Se(IV) or Se(VI), respectively. Cyclic voltammetry (CV) scans were conducted in both blank control and experimental systems between −0.8 V to 1.1 V with a scan rate of 50 mV s⁻¹. Between each test, the Au electrode was electrochemically cleaned by cycling between 0.3 V and 1.5 V for ten times to fully oxidize potential residues on the electrode surface, followed by a linear sweep voltammetry (LSV) scan from 0.3 V to 1.5 V to confirm complete removal of all residues on Au electrode. Following this cleaning protocol, the pH was fixed at 5.5 for the remainder of experiments. The effect of initial Se(IV) concentrations was evaluated on SeDER performance, ranging from 0.01 mM to 10 mM Se. For each Se(IV) concentration, an LSV scan was performed towards the negative direction from 0.3 V to −0.8 V to determine the Se reduction peaks, and a follow-up LSV scan towards the positive direction from 0.0 V to 1.5 V to oxidize surface-deposited products.

To probe the mechanism of Se(IV)DER, the inventors further utilized chronoamperometry (CA) to explore both four-electron Se(IV)/Se(0) and six-electron Se(IV)/Se(-II) reduction pathways. During each CA test, the cathode potential was held at −0.01 V, −0.25 V, or −0.61 V for 5 minutes to sustain Se(IV) reduction on the electrode surface. The initial Se(IV) level was increased to 10 mM in this test to enhance the mass transfer. After 5 minutes, an LSV scan was performed in the positive direction from 0.0 V to 1.5 V to reveal corresponding oxidation peaks of the surface-deposited reduction products. The inventors subsequently investigated the effect of temperature on SeDER with detailed quantification of Se deposition capacity or Se deposition rate on the gold electrode under three different solution temperatures, including 20° C., 40° C., and 80° C. The inventors selected a high temperature of greater than the 50-75° C. range to facilitate the formation of crystalline Se(0) during electroplating processes and avoid the deposition of insulative amorphous Se(0) during electrochemical reduction. A magnetic stirrer was placed inside (300 rpm) to ensure good mass transfer. As in the previous stage, the initial Se(IV) concentration was 10 mM, and each test lasted for 25 minutes.

The inventors also performed long-term SeDER experiments with 0.001 mM (79 μg L⁻¹), 0.01 mM (780 μg L⁻¹), and 0.1 mM (6.9 mg L⁻¹) Se(IV) to mimic Se levels common in industrial and agricultural wastewaters. Se(IV) concentration in the batch reactor was monitored to quantify Se removal rate or efficiency. Based on preliminary CV scans, the cathode was held at defined voltages corresponding to the four-electron or six-electron reduction pathway. The solution temperature was maintained under either 20° C. oricc 80° C. In the 6-h and 24-h tests, water samples (1 mL) were taken from the electrochemical cell every hour, and the filtered samples were preserved under 4° C. before quantification of soluble Se levels. Duplicate tests were performed in each experiment to ensure data accuracy and consistency.

Analytical Methods

Current and voltage data from CV, LSV, and CA are recorded by the BioLogic potentiostat (BioLogic Sciences Instruments). Total soluble Se concentration in the solution was quantified by inductively coupled plasma mass spectrometry (ICP-MS). Electrodes with surface deposits were preserved in a vacuum desiccator. Surface morphology and elemental mapping analysis of the gold electrodes was performed on a JEOL JXA-8230 electron probe microanalyzer (EPMA) with five wavelength dispersive X-ray spectrometers (WDS). Kinetics of electrode reactions in 0.1 mM Se(IV) was performed using LSV under various scan rates (5, 10, 20, 50, and 100 mV s⁻¹). Quantification of performance metrics, including Se removal efficiency (%), Se removal rate (mg h⁻¹ m⁻²), Se deposition capacity (mg m⁻²), and Faradaic efficiency (%), can be found Equations S1-S5 in Appendix B of U.S. Provisional Patent Application 63/073,583 filed Sep. 2, 2020, which is incorporated herein by reference and to which this application claims the benefit.

Results

Se(IV)DER and Se(VI)DER in a Weakly Acidic Environment

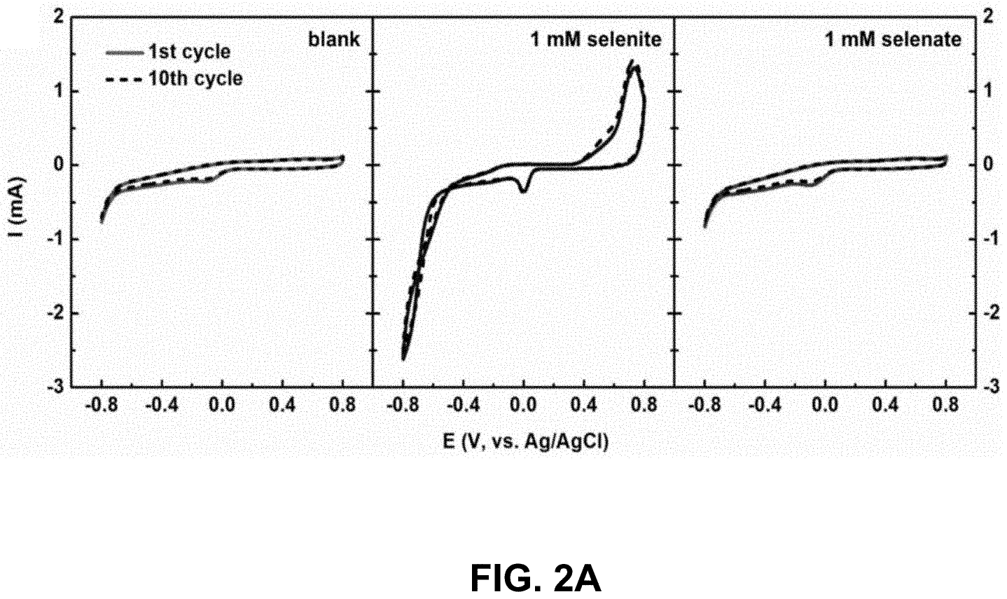

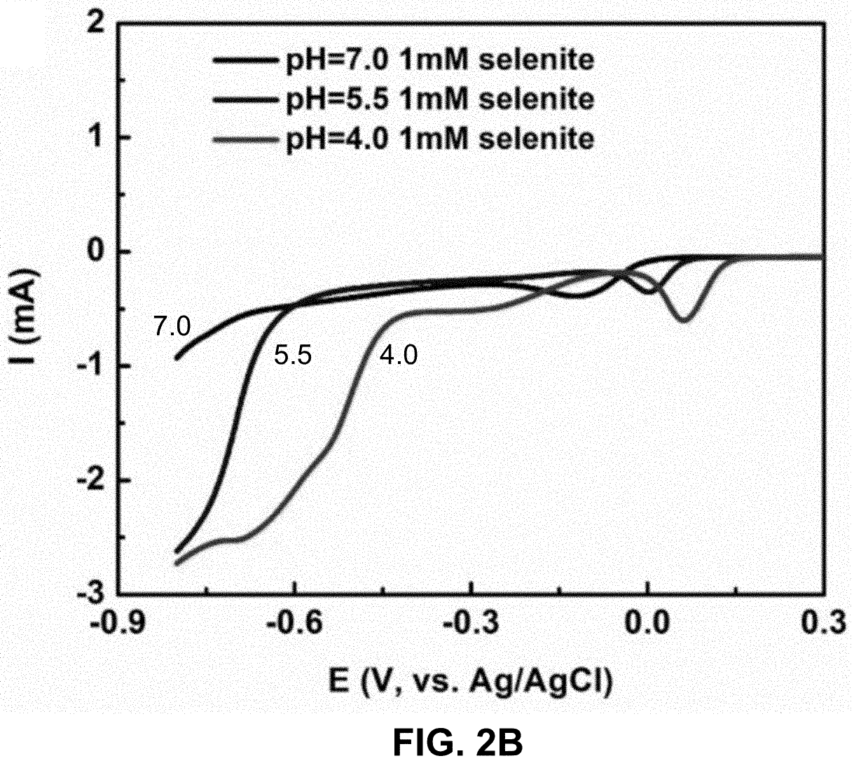

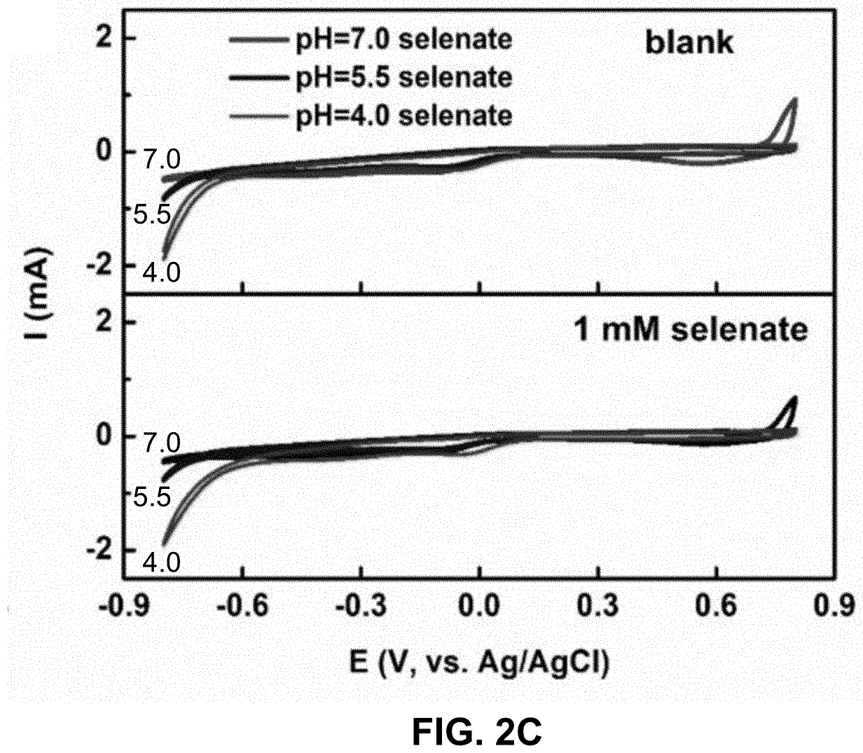

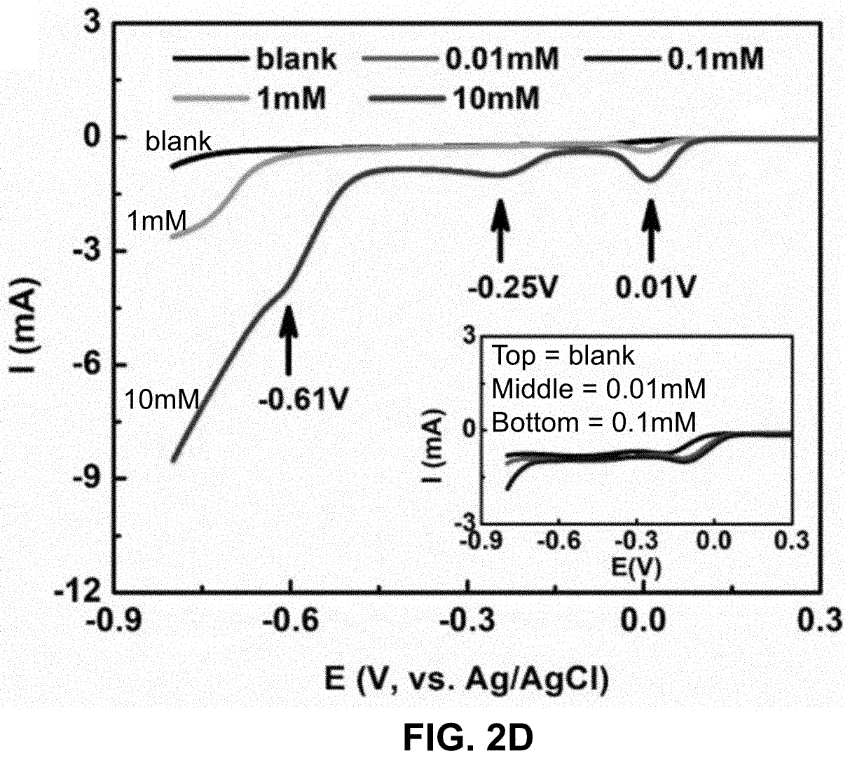

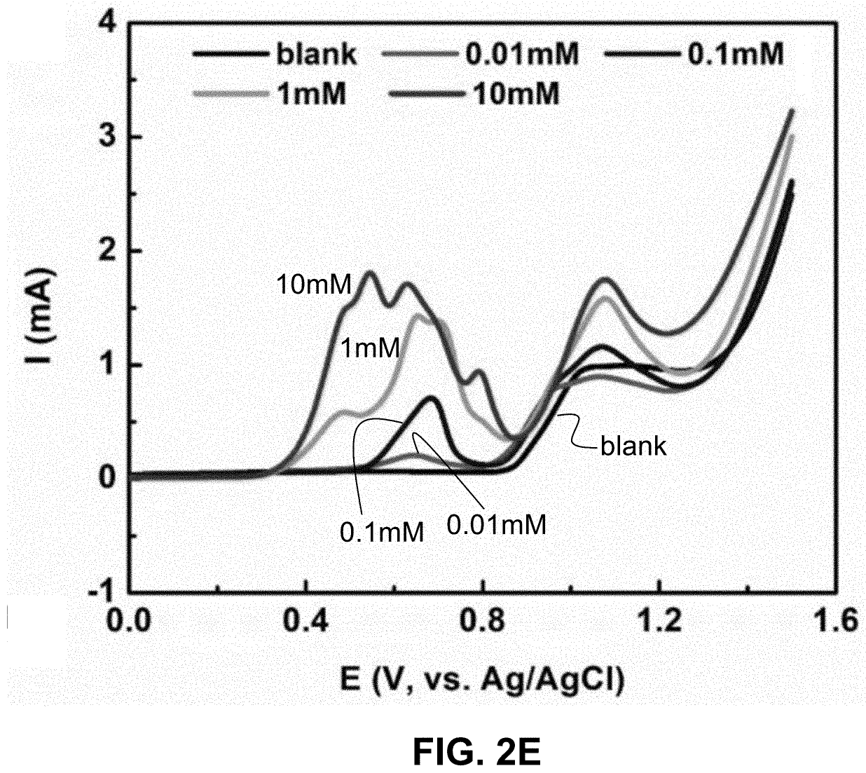

Se(IV) and Se(VI) oxyanions are the predominant species in industrial and agricultural wastewaters, with >80% of Se in its most oxidized state for some systems. At pH 5.5, the blank and Se(VI) CV curves are indistinguishable, but Se(IV) has distinct reduction peaks at a cathodic potential of approximately 0.0V (E vs. Ag/AgCl) and −0.6V (FIG. 2A). The second reduction peak may partially overlap with the hydrogen evolution reaction (HER) beginning at approximately −0.7V. These unique reduction peaks suggest that Se(IV) is effectively reduced on a gold electrode through two different electrochemical pathways, with generated products being subsequently oxidized under an anodic potential higher than 0.6V. The small plateau beginning at −0.1V in the blank control was attributed to the electrochemical desorption of surface-attached functional groups (e.g., Au—OH or Au—PO₄).

Theoretically, electrochemical Se(VI) reduction should be thermodynamically favorable, as indicated by the high redox potential of Se(VI)/Se(IV) couple (Eq. 1). However, the reduction of Se(VI) oxyanion to its Se(IV) counterpart is extremely slow due to the necessity of anion structure change and the high activation energy required to break the Se═O double bond. While it is possible to facilitate the conversion of Se(VI) to Se(IV) using solution-phase biological or metallic catalysts, doing so is not the focus of the present invention.

SeO₄²⁻+4H⁺+2e⁻↔H₂SeO₃+H₂O E°=0.95V (E vs. Ag/AgCl) (1)

Further investigated was Se(IV)DER under a wider pH range of 4.0-7.0 to reflect a typical pH profile of industrial and agricultural wastewaters. In theory, solution pH affects Se(IV)DER through two pathways: (1) the elemental composition of Se oxyanions and (2) the [H⁺] available for reaction. In common water matrices, the Se(IV) oxyanions are present as selenious acid (H₂SeO₃), biselenite (HSeO₃⁻), and selenite (SeO₃²⁻). Based on their pKₐ values (Eqs. 2 and 3), the inventors expected a comparable amount of SeO₃²⁻ and HSeO₃⁻ at pH 7.0 and a majority of HSeO₃⁻ at pH 5.5. Further decrease of solution pH to 4.0 would lead to a mixture of H₂SeO₃ and HSeO₃⁻ with negligible presence of SeO₃²⁻.

H₂SeO₃⁻↔HSeO₃⁻+H⁺ pKₐ₁=2.5 (2)

HSeO₃⁻↔SeO₃²⁻+H⁺pKₐ₂=7.3 (3)

Variation of Se(IV) composition induced by pH changes was well supported by observed reduction peaks in the LSV scan. At pH 7.0, two reduction peaks were identified for HSeO₃⁻ (FIG. 2B), including HSeO₃⁻/Se (E=−0.13V, Eq. 4) and HSeO₃⁻/H₂Se (onset at −0.70V, Eq. 5). However, the absence of SeO₃²⁻ reduction peaks is a result of the significantly more negative theoretical reduction potential (Eq. 6). At pH 5.5, SeO₃²⁻ is primarily present as HSeO₃⁻ and exhibited reduction peaks for HSeO₃⁻/Se (0.0V) and HSeO₃⁻/H₂Se (onset at −0.60V). In a more acidic environment (i.e., pH=4.0), H₂SeO₃ is formed in solution from HSeO₃⁻, leading to two additional reduction peaks for H₂SeO₃/Se (E=−0.25V, Eq. 7) and H₂SeO₃/H₂Se (E=−0.70V, Eq. 8). Given the reduction potentials of these three Se(IV) species in industrial and agricultural wastewaters, the energy efficiency of Se(IV)DER may benefit from manipulating the solution pH to convert both H₂SeO₃ and SeO₃²⁻ to HSeO₃⁻. Note that the reference E° in all equations are standard reduction potentials measured under standard conditions (i.e., 1 M Se and 1 M H⁺), and the observed E from experiment tends to be more negative due to the overpotential.

HSeO₃⁻+5H⁺+4e⁻↔Se+3H₂O E°=0.58V (E vs. Ag/AgCl) (4)

HSeO₃⁻+7H⁺+6e⁻ ↔H₂Se+3H₂O E°=0.19V (E vs. Ag/AgCl) (5)

SeO₃²⁻+3H₂O+4e⁻ ↔Se+6OH⁻ E°=−0.57V (E vs. Ag/AgCl) (6)

H₂SeO₃+4H⁺+4e⁻↔Se+3H₂O E°=0.54V (E vs. Ag/AgCl) (7)

H₂SeO₃+6H+6e⁻↔H₂Se+3H₂O E°=0.16V (E vs. Ag/AgCl) (8)

Higher concentrations of H⁺ ions in the water matrix will promote the reaction rate, as SeDER consumes a large amount of H⁺. Meanwhile, the Nernst equation dictates that Se reduction potential is strongly dependent on the [H⁺] in solution. For instance, assuming 1-M HSeO₃⁻ is available in the solution, a pH increase from 0 (standard condition) to 5.5 would drop the reduction potential from 0.58V to 0.21V (273K, Eq. S6). This result was confirmed by a positive shift of the HSeO₃⁻/Se reduction peak from −0.13V (pH=7.0) to 0.06V (pH=4.0, FIG. 2B). This positive shift in reduction peak induced by a pH decrease would require a less negatively biased cathode, which could reduce parasitic reactions on the cathode and the energy input. These conclusions align well with best practices in Se electroplating, which typically use a strong acid bath at pH 1-2 to ensure minimum energy input and high Se-film purity. The obtained results indicate that one could achieve successful Se(IV)DER in a weakly acidic environment, with HSeO₃⁻ being the preferred species for reduction. Se(VI)DER is a relatively inert process at pH 4-7 (FIG. 2C).

Effect of Selenite Concentration

In contrast to a controlled Se level in electroplating, the Se concentration in wastewater effluent is highly variable and may substantially affect SeDER. The inventors investigated Se(IV)DER for a series of initial Se(IV) concentrations ranging from 0.01 mM to 10 mM at pH 5.5 (i.e. the average pH of FGD wastewater). Initially, a negative direction LSV scan was applied to probe electrochemical reactions in the water matrix. The Nernst equation predicts an increase in Se(IV) concentration will shift the reduction potential in the positive direction, while better mass transfer at high Se(IV) concentration is expected to enhance reduction rate and the peak heights in voltammetry. Consistent with theory, minor reduction peaks were observed for Se(IV) concentrations of 0.01 mM and 0.1 mM (FIG. 2D, inset), while two new Se reduction peaks emerged at 1 mM Se(IV). Based on the LSV curve of 10 mM Se (FIG. 2D), three notable reduction peaks were identified at 0.01V and −0.25V for a four-electron reduction pathway (Se(IV)/Se(0), Eq. 4), and −0.61V for a six-electron reduction pathway (Se(IV)/Se(-II), Eq. 5). Once Se(-II) is generated, a homogenous chemical reaction (Eq. 9) may yield elemental Se(0), and this chemical reaction is more favored in acidic and intermediate pH ranges.

2H₂Se+H₂SeO₃↔3Se+3H₂O (9)

A positive LSV scan further probed the Se reduction products on the Au electrode into the oxidation region. A single oxidation peak was identified between 0.6-0.7V (green (0.01 mM) and blue (0.1 mM) lines, FIG. 2E), revealing a Se(0) layer from underpotential deposition, though the inventors were unable to visualize red Se films at 0.01 mM and 0.1 mM Se(IV). At Se(IV) concentrations of 1 to 10 mM, three additional oxidation peaks appeared, and visually noticeable red Se films formed on the electrode surface. These four oxidation peaks are attributed to oxidation of chemically precipitated Se(0) at 0.49 V, bulk deposited Se(0) at 0.55 V (Se—Se bond), underpotentially deposited Se(0) at 0.63 V (Se—Au bond), and subsurface intermetallic Se—Au composite at 0.79V (within the Au lattice), respectively. It is also worth noting that nearly all surface deposits were oxidized during the electrochemical cleaning, enabling convenient electrode regeneration, prolonged electrode lifespan, and reduced lifecycle treatment costs.

Four-Electron Vs. Six-Electron Reduction Pathway

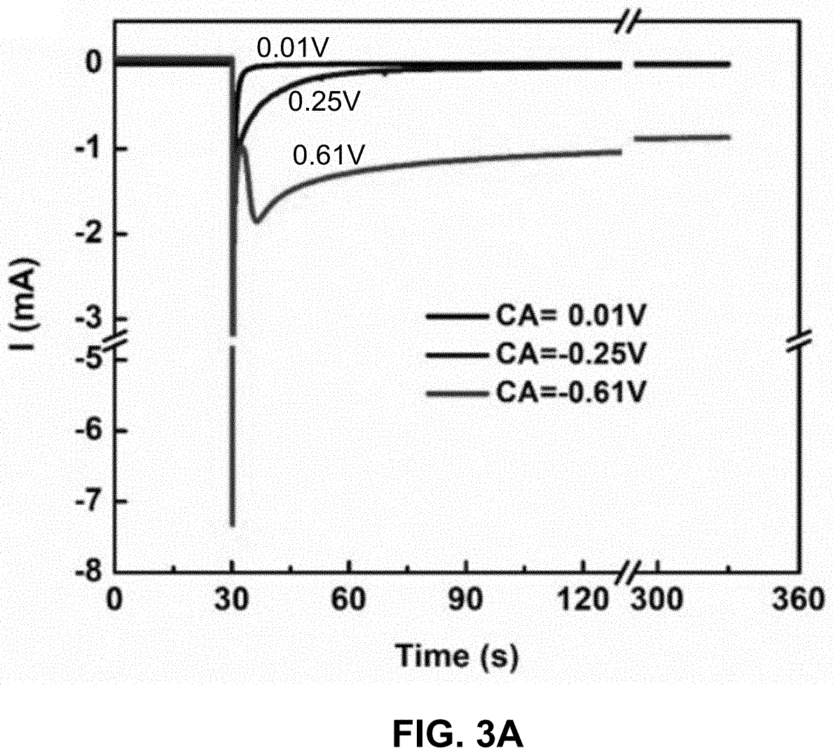

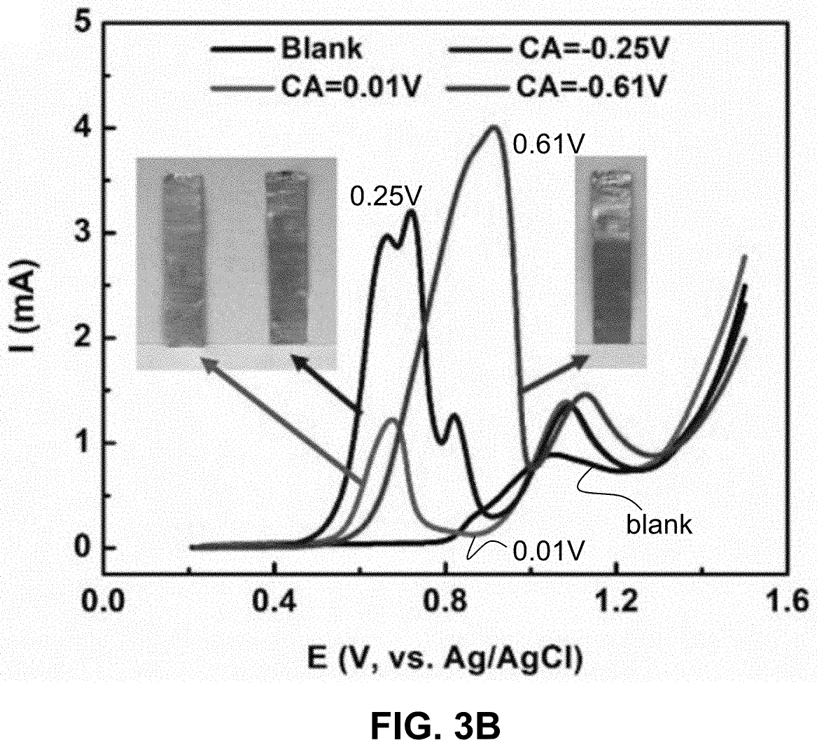

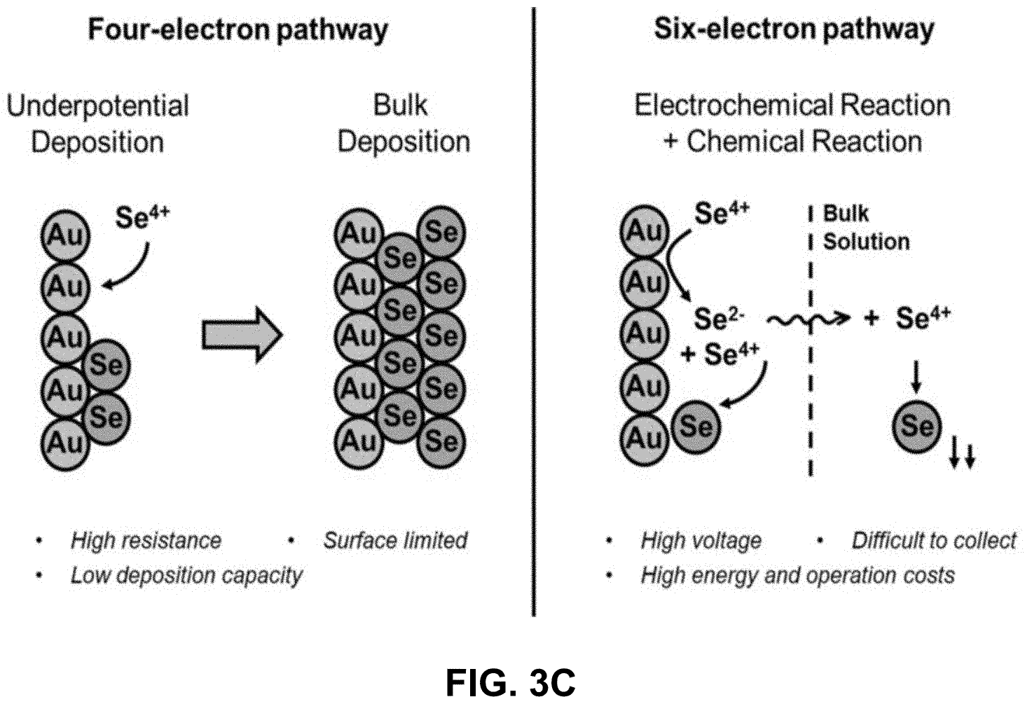

Selecting between four- and six-electron Se reduction pathways for wastewater treatment requires a comprehensive evaluation of the tradeoffs of each approach. Within the four-electron pathway, underpotential deposition is energetically favored by Au—Se interaction and onsets at a more positive potential than that of the bulk deposition. Hence, the inventors first evaluated SeDER through underpotential deposition and held the Au electrode at 0.01V for 5 mins. Rapid termination of underpotential deposition was observed within 10 seconds (black (CA=0.01V)) line, FIG. 3A), removing a theoretical (and maximum) amount of 6.8×10⁻⁹ mol Se (˜0.0007%) based on the current data. The reduced Se(0) would form a 160-pm layer on the Au electrode (assuming a density of 4.8 g cm⁻³), comparable to the thickness of Se monolayer in electrodeposition on Au (200-300 pm). A single oxidation peak confirmed this Se(0) layer in the positive LSV scan (green (CA=0.01V) line, FIG. 3B). The results revealed that underpotential deposition is not suitable for SeDER owing to its extremely limited deposition capacity (0.77 mg m⁻²). In subsequent tests, a pristine Au electrode was held at −0.25V for 5 mins to enable both underpotential and bulk deposition (FIG. 3C). Still, the deposited red Se(0) (i.e. the amorphous Se) with low electrical conductivity (σ=10⁻¹² to 10⁻¹⁴ ohm⁻¹ cm⁻¹) would convert the conductive Au electrode to a nearly insulative Se electrode. It was estimated that 0.005% of the Se(IV) was removed, forming a Se layer of ˜1200 pm. Subsequent positive LSV scan revealed three oxidation peaks for bulk deposition (0.66 V), underpotential deposition (0.72 V), and subsurface intermetallic Au—Se composite (0.82 V), respectively (blue (CA=0.25V) line, FIG. 3B). The limited Se deposition capacity (5.72 mg m⁻²) was supported by surface morphology and elemental mapping results. Hence, SeDER through a four-electron pathway (either underpotential or bulk deposition) is a surface-limited process and less competitive for continuous Se control.

Se(IV) reduction via the six-electron pathway generates soluble hydrogen selenide (H₂Se, aqueous) that will not cover the electrode surface, serving as a promising alternative for continuous Se removal if H₂Se could be effectively neutralized by Se(IV) in the solution phase (Eq. 9). When the Au electrode was held at −0.61 V, an interesting trend was observed of a decrease-increase-decrease current profile in duplicate tests (red (CA=0.61V) line, FIG. 3A), potentially owing to a dynamic H₂Se concentration in the diffusion layer controlled by electrochemical production and consumption via chemical precipitation and physical diffusion. Note that a considerable amount of generated amorphous Se(0) was attached to the electrode surface, forming a visible red film on the Au electrode. Oxidation of the chemically precipitated Se(0) on the Au electrode revealed distinct peaks compared to that of the four-electron pathway (FIG. 3B, red (CA=0.61V) line). The remaining elemental Se(0) were either suspended in the solution or settled at the bottom of the cell, requiring downstream filtration or other polishing steps to fully remove these Se particles. Hence, SeDER via six-electron pathway could offer continuous Se removal, at the expense of higher exerted voltage, low Se recovery, and elevated operational cost due to downstream polishing.

When comparing four- and six-electron pathways, one needs to consider the complexity of the industrial and agricultural wastewaters. These wastewaters could contain high levels of other oxyanions (up to three orders of magnitude higher than Se), such as nitrate, nitrite, phosphate, sulfate, and metal oxyanions. While not the focus of the present invention, future work evaluating the respective pathways will need to perform similar experiments in the presence of competing ions relevant to the specific wastewater of interest. Nevertheless, the present results suggest that the negatively biased cathode under the six-electron pathway may promote parasitic reactions and lead to low Faradaic efficiencies. Extensive pretreatment to remove competing ions may improve the efficiency of the six-electron pathway, but would likely come with higher capital and operational costs. In contrast, four-electron SeDER excels in system-level energy input, fewer parasitic reactions, and convenient collection of Se(0). Operational strategies could be implemented to tackle surface-limited reduction mechanism and enhance surface deposition capacity and Se removal efficiency, resulting in a more economically competitive four-electron SeDER.

Effect of Solution Temperature

Solution temperature is a vital operational parameter in SeDER that will affect not only the reaction rate, but also the phase of the deposited Se(0). In this section, three solution temperatures were investigated for four-electron bulk deposition, including 20° C., 40° C., and 80° C. The latter two solution temperatures were selected to represent some industrial wastewaters, e.g. FGD wastewater has an average temperature of −55° C. Under 20° C. and 40° C., the current gradually dropped to steady state at −0.020 mA and −0.037 mA, respectively, over the course of the 25-min experiment. Given that the four-electron bulk deposition is a surface-limited process, these stable currents were potentially sustained by background parasitic reactions, with a faster reaction rate (and hence higher background current) at 40° C. The Se deposition capacity was estimated to be 8.52 mg m⁻² at 20° C. The capacity was further increased to 13.25 mg m⁻² at 40° C., though the inventors could not visually identify red Se(0) films at either temperature.

Further increase of solution temperature to 80° C. led to a relatively consistent current profile around −0.150 mA. This significantly higher current indicated that the inventors were not depositing insulative amorphous Se(0) on the electrode, but rather conductive crystalline Se(0) with significantly higher conductivities of σ=10⁻⁴ ohm⁻¹ cm⁻¹ at 80° C. This hypothesis was supported by visual observation of a metallic grey Se film on the electrode surface and a previous electroplating study (>55° C.). Formation of crystalline Se(0) on the electrode surface effectively converts the conductive Au electrode interface to a conductive Se electrode interface, offering an innovative solution to the surface-limited four-electron reduction pathway at lower temperatures. This approach may be particularly well suited for high temperature industrial wastewater treatment where additional heat input would be minimal.

Long-Term Electrochemical Se Removal and Faradaic Efficiency

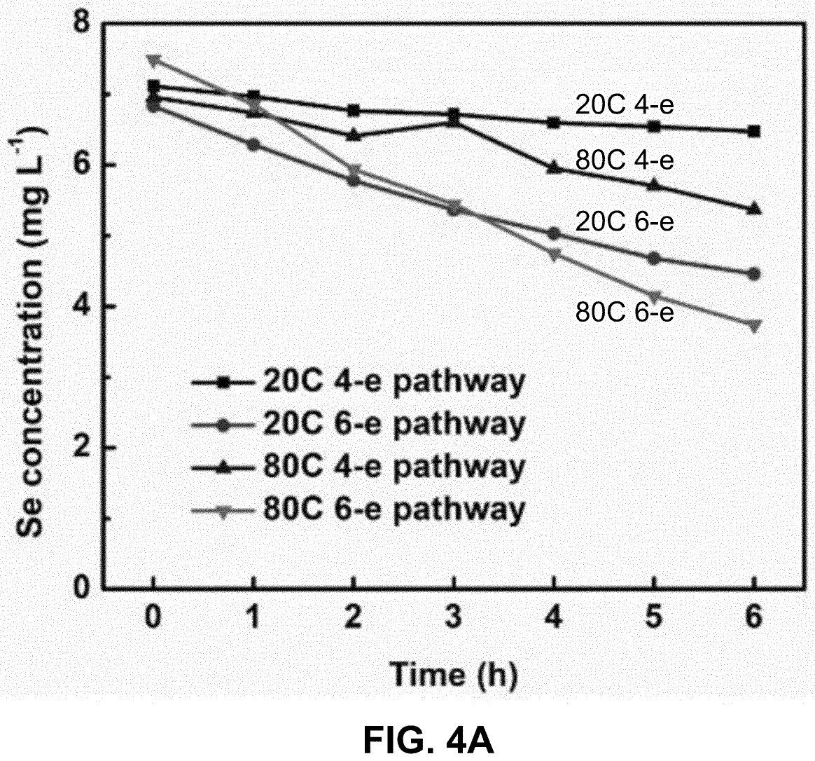

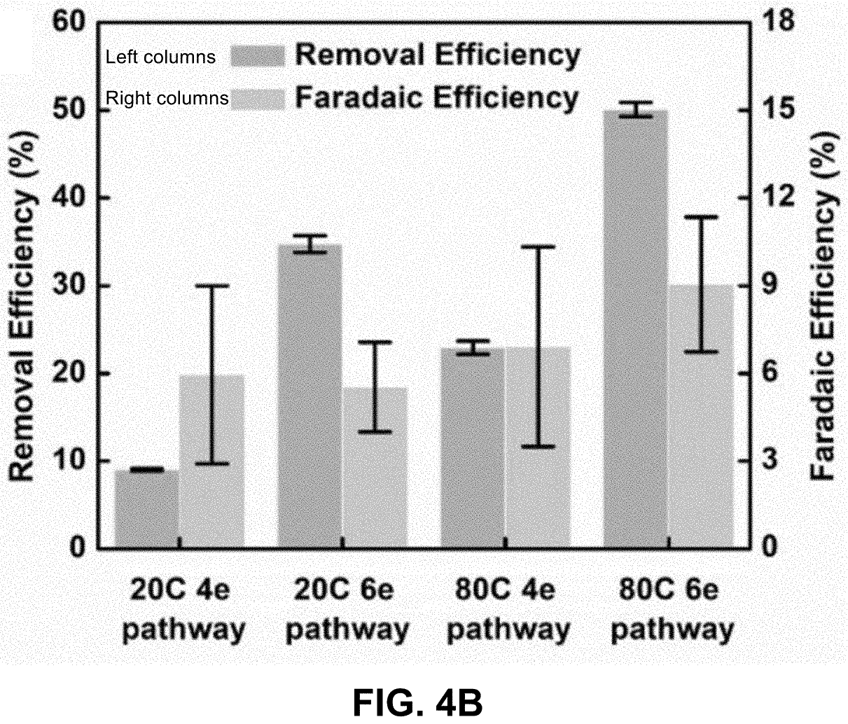

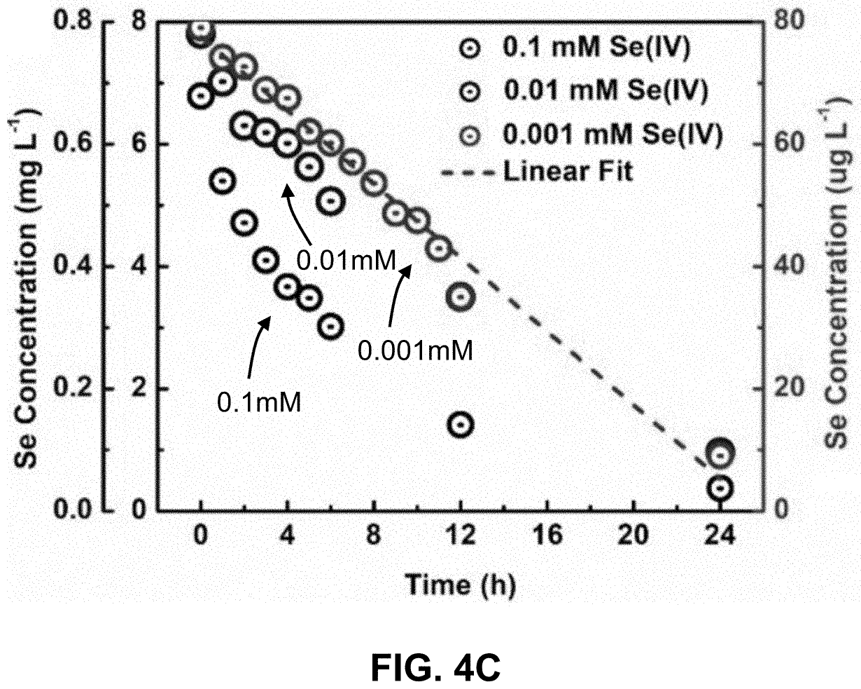

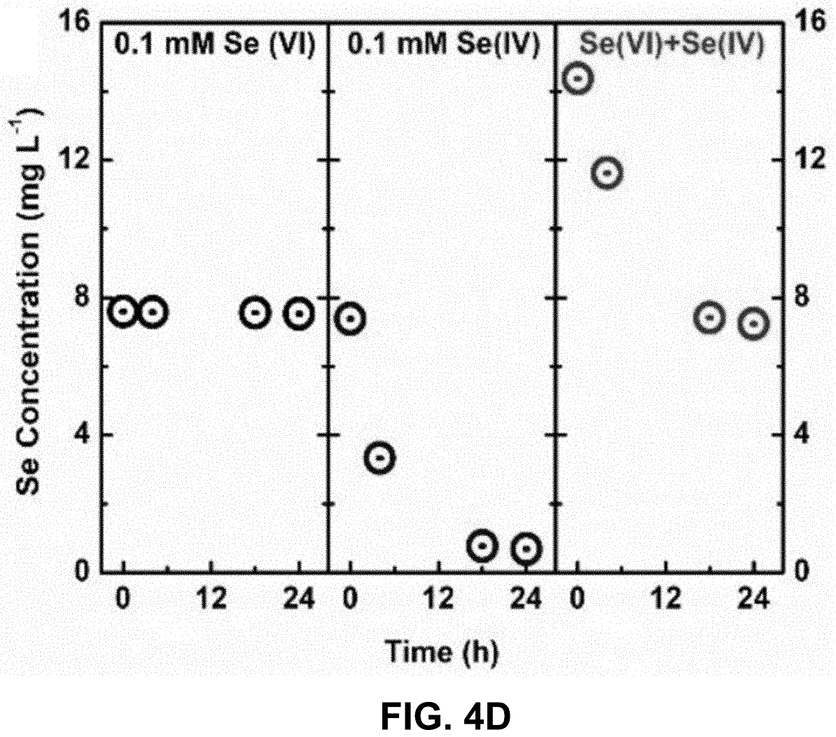

While the inventors comprehensively investigated the operation parameters and reduction pathways of SeDER, it is of vital importance to further evaluate the extent of Se removal and the Faradaic efficiency in long-term operation. In 6-hour tests at 0.1 mM Se(IV) and 20° C. (FIG. 4A), the four-electron pathway Se(IV) concentration decreased only slightly, with removal efficiencies of 9.0% and a Faradaic efficiency of 6.0% (FIG. 4B). Increasing the solution temperature to 80° C. led to both an increased removal efficiency of 34.7% and an increased Faradaic efficiency of 6.9%. Crystalline grey Se(0) was deposited on the electrode surface, and the inventors observed no generation of suspended or settled solids. A follow-up kinetic analysis was performed with scan rates ranging from 5 to 100 mV s⁻¹. These results suggest that four-electron pathway is a quasi-reversible reaction controlled by mass transport (i.e. diffusion limited), with a diffusion coefficient and standard rate constant of 6.94×10⁻⁵ cm² s⁻¹ and 3.16×10⁻⁷ cm s⁻¹. To conclude, Se removal via a four-electron pathway will either require a large electrode surface or extended retention times to lower the Se level in wastewaters for U.S. EPA compliance.

The inventors further decreased the cathode potential to −0.60 V (20° C.) or −0.50 V (80° C.) and conducted SeDER via a six-electron pathway. Note that the cathodic potential for both pathways was determined by LSV scan prior to the long-term experiment. At 20° C., the Se concentration dropped continuously from 6.83 to 4.46 mg L⁻¹ over the 6-h experiment (FIG. 4A), with an average Se removal rate of 56.48 mg m⁻² h⁻¹, a total removal efficiency of 34.7%, and a Faradaic efficiency of 5.5%. A large portion of generated red Se(0) was suspended in the solution. Increasing the solution temperature to 80° C. resulted in an elevated Se removal rate of 89.29 mg h⁻¹ m⁻², a higher removal efficiency of 50.1%, and a more desirable Faradaic efficiency of 9.0% (FIG. 4B). With system-level optimization (e.g. better reactor design to facilitate mass transport and electrode selection to mitigate parasitic reactions), one can further boost the Faradaic efficiency of SeDER system and reduce the operating costs of the Se removal processes. The inventors also identified crystalline grey Se(0) at the bottom of the cell. An over 50% removal in 6 hours suggests that the six-electron pathway was kinetically favorable compared to the four-electron pathway, though the inventors could not perform an accurate kinetic analysis due to a failure to separate the Se(IV)/Se(-II) peak from the hydrogen evolution reaction peak at pH 5.5 in both LSV and rotating disk electrode tests. A kinetic study confirmed that six-electron pathway is also controlled by mass transport, and the standard rate constant of Se(IV)/Se(-II) is three orders of magnitude higher than Se(IV)/Se(0) at pH 2.

Eventually, the operation time of six-electron SeDER was extended to 24 hours for maximum Se removal under 80° C. (FIG. 4C). We started with 0.1 mM Se (6.79 mg L⁻¹) to simulate a typical Se concentration in FGD wastewater, achieving a 6-h, 12-h, and 24-h removal efficiency of 55.6%, 79.2%, and 94.5%, respectively. Under 0.01 mM (0.78 mg L⁻¹) and 0.001 mM Se (79.05 μg L⁻¹), SeDER is a more mass-transfer constrained process and achieved slightly lower 24-h removal efficiencies (87-89%), compared to that of 0.1 mM Se(IV). Based on the results, SeDER could serve as bulk removal and polishing processes to manage diluted Se water streams. It demonstrated the capability to meet EPA ELG daily maximum (23 μg L⁻¹, 18-h operation) and monthly average discharging standards (12 μg L⁻¹, 22-h operation), based on the linear fit under 0.001 mM (R²=0.98, FIG. 4C). Se(VI) was not reduced over 24-h of operation with an electrode potential of −0.5V at 80° C. (left panel, FIG. 4D). The inventors observed 6.9 mg L⁻¹ Se removal in both Se(IV) and Se(IV)+Se(VI) experimental groups (middle and right panels, FIG. 4D), with comparable Faradaic efficiency of ˜6.6%. Hence, the presence of Se(VI) in aqueous solution is not expected to interfere with electrochemical Se(VI) reduction by occupying reaction sites or competing for electrons.

Additional Notes
In one example, the competing ion, sulfate, promotes electrochemical selenite removal efficiency by 11-23%.
In another example, the competing ion, nitrate, hinders electrochemical selenite removal efficiency by 2-11%.
In yet another example, the competing ion, chloride, triggers parasitic chlorine evolution reaction and decreases electrochemical selenite removal efficiency by 1-8%.
In yet another example, with embodiments of this invention one could remove up to 97% selenite from simulated flue-gas desulfurization wastewater through electrochemical selenite reduction.
In yet another example, with embodiments of this invention one could achieve a threshold selenium deposition capacity of 3.5 g m⁻² on an unmodified gold foil electrode.
In still another example, with embodiments of this invention, the electrode can be easily regenerated through electrochemical oxidation.

What is claimed is:

1. A method for removing selenium from wastewater using a direct electrochemical reduction, the method comprising:
(a) passing the wastewater through a reactor containing electrodes;
(b) applying a predetermined electric potential between the electrodes immersed in the wastewater, while the reactor has a pH of 4-7;
(c) controlling the temperature of the wastewater between the electrodes so that it attains a temperature above the amorphous-to-crystalline transition for Se(0); and
(d) periodically removing from the reactor crystalline selenium deposited on one of the electrodes.

2. The method as set forth in claim 1, wherein the electrodes are an Au electrode, an Ag/AgCl electrode and a Pt electrode.

3. The method as set forth in claim 1, wherein the temperature is controlled to be above 75° C., or 80° C. or more.

4. The method as set forth in claim 1, further comprising using chronoamperometry to control the predetermined electric potential at a constant voltage and a changing current.

5. The method as set forth in claim 4, wherein two of the electrodes are an Au electrode and an Ag/AgCl electrode, and wherein the constant voltage on the Au electrode is between 0.0V to −0.4V versus the Ag/AgCl reference electrode, wherein the Ag/AgCl reference electrode has a 3.5M potassium chloride filling solution.

6. The method as set forth in claim 1, wherein the predetermined electric potential produces a current density of less than 1.5 A/m².

7. The method as set forth in claim 1, wherein the wastewater contains Se concentrations of 0.0001M to 0.001M, nitrate concentrations of 0 to 0.01M, sulfate concentrations of 0 to 0.2M, chloride concentrations of 0 to 0.5M, or any combination thereof.

8. The method as set forth in claim 1, wherein the method selectively reduces selenium through 4 and 6 electron pathways, thereby avoiding reduction of competing ions.

9. The method as set forth in claim 1, wherein one of the electrodes is an Au electrode, and wherein the deposited crystalline selenium on the Au electrode can reach a deposition capacity of at least 3.0 g Se per square meter electrode surface area.
